(19) United States
(12) Patent Application Publication
(10) Pub. No.: US 2013/0308840 A1
(43) Pub. Date: Nov. 21, 2013

(54) CHEMICAL ENTITY SEARCH, FOR A COLLABORATION AND CONTENT MANAGEMENT SYSTEM

(71) Applicant: Targacept, Inc., (US)

(72) Inventors: Kartik Tallapragada, Ryersford, PA (US); Joseph Chewning, Winston-Salem, NC (US); David Kombo, Winston-Salem, NC (US); Beverly Ludwick, Winston-Salem, NC (US)

(73) Assignee: Targacept, Inc., Winston-Salem, NC (US)

(21) Appl. No.: 13/867,432

(22) Filed: Apr. 22, 2013

Related U.S. Application Data
(60) Provisional application No. 61/637,267, filed on Apr. 23, 2012.

(51) Int. Cl. G06F 17/30

(52) U.S. Cl. CPC G06F 17/30253
USPC 382/128

(57) ABSTRACT

A method of obtaining chemical or molecular compound information from a document is provided. The method includes applying optical structure recognition to a document and extracting compound structure information from data obtained by applying the optical structure recognition. The method includes applying a text search module to a main body of the document and metadata of the document and extracting one or more chemical names from data obtained by applying the text search module to the main body and to the metadata. The method includes storing, in a database, an identifier, the compound structure information, and the one or more chemical names, wherein at least one method operation is executed through a processor.

This application claims benefit of priority from U.S. Provisional Application No. 61/637267 filed Apr. 23, 2012, which is hereby incorporated by reference in its entirety for all purposes.

### BACKGROUND

Drug discovery is a time consuming and labor intensive process. The ability to efficiently and accurately identify compounds to further evaluate is valuable in the drug discovery process. One software tool utilized in the drug discovery process is search software that attempts to identify documents disclosing information on a desired compound. Current software tools utilized in the drug discovery process are limited in their ability to search and identify possible compound candidates due to their inability to search documents having non-searchable image data and/or extract data associated with the document text or metadata of the document.

It is within this context that the embodiments arise.

### SUMMARY

Embodiments of the present invention include a method and apparatus for performing an accurate search of chemical or molecular compounds to enhance the drug discovery process. It should be appreciated that the present invention can be implemented in numerous ways, such as a process, an apparatus, a system, a device, or a method on a computer readable medium. Several inventive embodiments of the present invention are herein described.

In one embodiment, a method of managing a database relating to chemical or molecular compounds is provided. The method includes extracting at least one first chemical name from the document in response to at least a portion of the document having a type of text format and extracting compound structure information via optical structure recognition applied to the document in response to the document having at least one image. The method includes extracting at least one second chemical name via optical character recognition applied to the document in response to the document having text that is susceptible to optical character recognition and extracting at least one third chemical name from metadata of the document in response to the document having metadata. The method includes extracting molecular string information from the document in response to the document having molecular string information and storing in a database, under an identifier associated with the document, the compound structure information, the at least one first chemical name, the at least one second chemical name, the at least one third chemical name, the molecular string information and the compound structure information.

In another embodiment, a method of obtaining chemical or molecular compound information from a document is provided. The method includes applying optical structure recognition to a document and extracting compound structure information from data obtained by applying the optical structure recognition. The method includes applying a text search module to a main body of the document and metadata of the document and extracting one or more chemical names from data obtained by applying the text search module to the main body and to the metadata. The method includes storing, in a database, an identifier, the compound structure information, and the one or more chemical names, wherein at least one method operation is executed through a processor.

In another embodiment, a system for managing a database relating to chemical or molecular compounds is provided. The system includes a memory having a text search module and an optical structure recognition module stored therein. The system includes a processor coupled to the memory. The processor is configured to execute instructions causing the processor to crawl through a plurality of documents; extract one or more chemical names from a document of the plurality of documents via an application of the text search module to the document and via an application of the text search module to metadata of the document; extract compound structure information from the document via an application of the optical structure recognition module to the document; extract molecular string information from the document; and store an identifier, location information of the document, the one or more chemical names, the compound structure information and the molecular string information.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a flowchart diagram illustrating the method operations for efficiently and accurately identifying compounds to further evaluate in the drug discovery process in accordance with one embodiment.

FIG. 2 is a flowchart diagram illustrating the method operations performed by the optical structure recognition module of FIG. 1 in accordance with one embodiment.

FIG. 3 is a flowchart diagram illustrating the method operations for extracting chemical names from a document in accordance with one embodiment.

FIG. 4 is a flowchart diagram illustrating the method operations for obtaining metadata information from a document in accordance with one embodiment.

FIGS. 5A and 5B are simplified schematics illustrating graphical user interfaces (GUIs) where a user may initiate the enhanced search capability of a CHEMICALLY AWARE™ Collaboration and content management system in accordance with one embodiment.

FIG. 6 is a simplified schematic diagram illustrating a computing system having the enhanced search capability in accordance with one embodiment.

FIG. 7 is a flowchart diagram illustrating the high level method operations for the CHEMICALLY AWARE™ Collaboration and content management system functionality in accordance with one embodiment.

### DETAILED DESCRIPTION

The following embodiments describe a method and apparatus for a CHEMICALLY AWARE™ Collaboration and content management system that provides enhanced accuracy for searching chemical structures and chemical names. It will be obvious, however, to one skilled in the art, that the present invention may be practiced without some or all of these specific details. In other instances, well-known operations have not been described in detail in order not to unnecessarily obscure the present invention.

The embodiments described herein enable the searching of non-OCRable image data, e.g., image data that is not amenable to regular text-based searches, in a document management system. In one embodiment, a search is initiated by drawing a molecular structure within any suitable computer assisted drawing program and triggering the search through a graphical user interface (GUI) that is associated with the drawing program and the search algorithm that is described herein. The search algorithm captures data from one or more of the structure, the chemical name for the structure and any metadata for a particular document identified in the search. In one embodiment, structure recognition software converts a non-searchable image, including but not limited to a .pdf (portable data format) file extension, a .jpeg (joint photographic experts group) file extension, and the like, to a so-called live structure. As used herein the phrase “live structure” refers to the chemical or molecular entity that can be represented in any of the following formats including but not limited to molstring, smiles, inchi, chime, etc. The inclusion of the chemical names from the document, irrespective of naming convention, as well as the metadata information, along with the optical structure recognition features will enable enhanced accuracy of search results so that more relevant documents are located through the search process. This captured data is then stored and indexed in a relational database with each document being assigned a unique document identifier (ID). It should be appreciated that as more searches are performed the relational database continues to be built and provides a powerful tool for drug discovery as documents are readily available based on the ID. In another embodiment, the search algorithm includes a forecasting engine that may provide one or more forecasts for therapeutic indications for which the molecular structure may be therapeutically effective or may forecast a pharmacological activity of the molecular structure using pre-defined algorithms.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

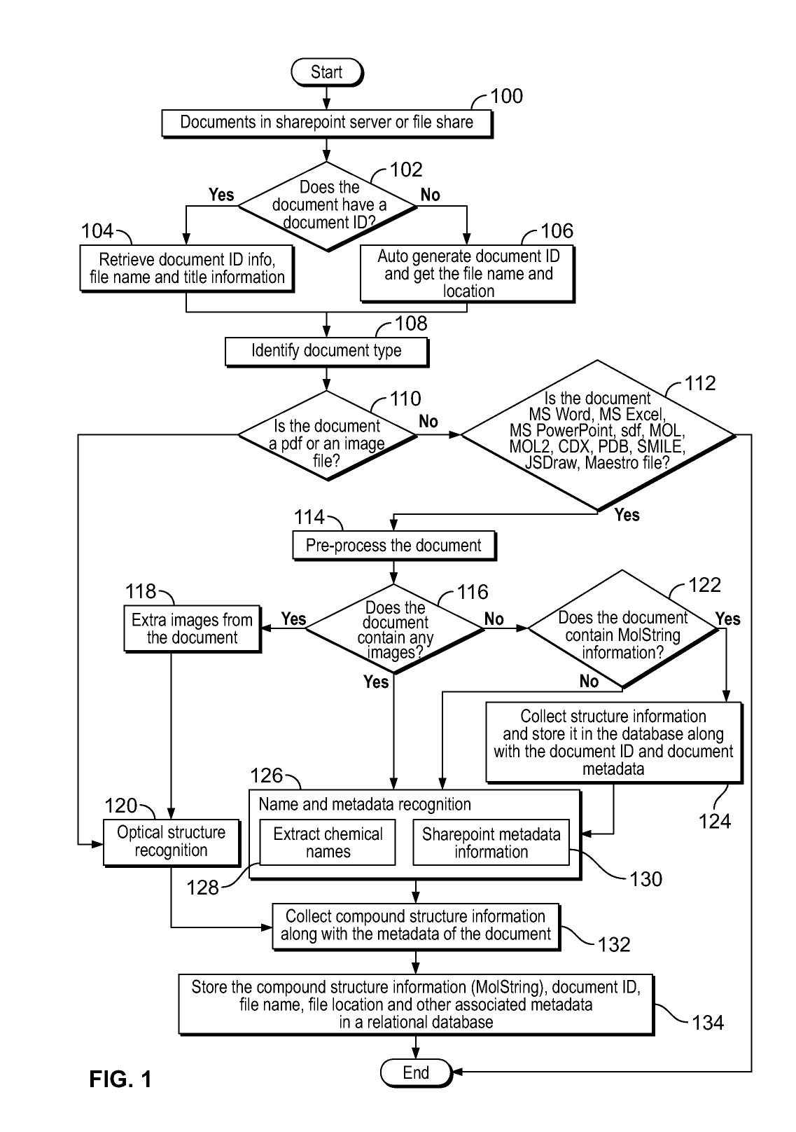

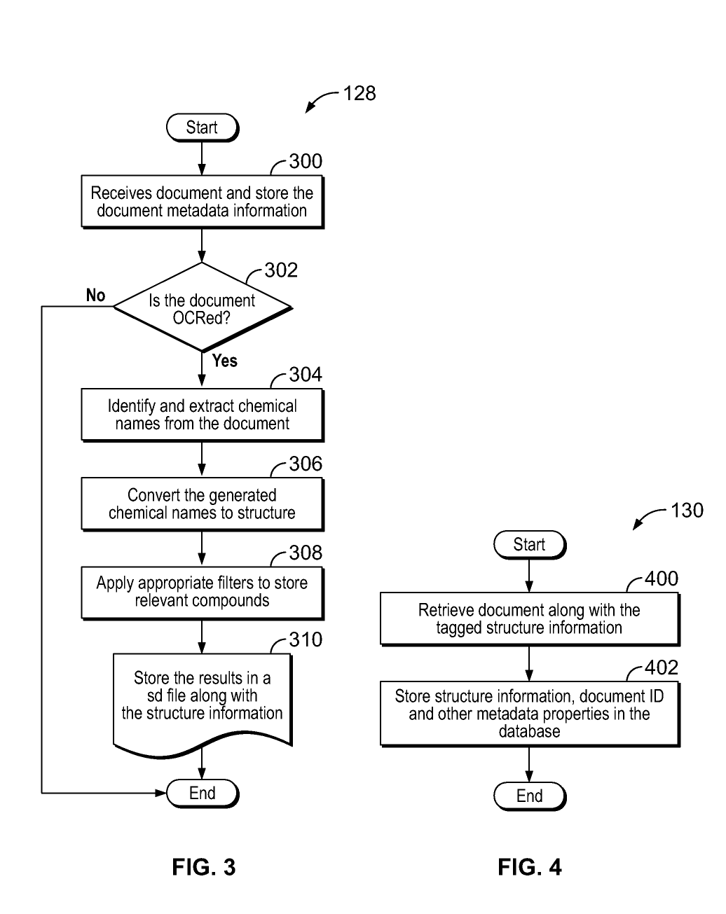

FIG. 1 is a flowchart diagram illustrating the method operations for efficiently and accurately identifying compounds to further evaluate in accordance with one embodiment. The flowchart initiates with operation 100 where documents in a Collaboration and content management software system or file share are identified. In one embodiment, the Collaboration and content management system or file share is a relational database that includes software and hardware. It should be appreciated that the search is not limited to a single document management system and may include searching many databases, each of which is accessible through a network connection. The method then advances to decision operation 102 where it is determined if the document from operation 100 includes a unique document ID. If the document includes a unique document ID then the method proceeds to operation 104 where the document ID information, file name and title information are retrieved. If the document does not include a document ID then the method proceeds from operation 102 to operation 106 where a document ID is generated and the file name and location are obtained. Once the document ID has been obtained the method proceeds to operation 108 where the document type is identified. It should be appreciated that the document type may be identified through a file extension of the document in one embodiment. The method then proceeds to decision operation 110 where it is determined if the document is a portable document format (PDF) file or image file based on the associated file extension. It should be appreciated that in operation 110 the algorithm is determining whether the document is a searchable document. If the document is of a PDF or image file type, then the method proceeds to operation 120 where a structure recognition algorithm converts the document to a searchable document to extract any chemical or compound structure information within the document. Further details of operation 120 are provided below with reference to FIG. 3.

Still referring to FIG. 1, if the document is not a PDF or image file type, the method proceeds to decision operation 112 where the document type of the file is determined. It should be appreciated that the document types listed in decision operation 112 are exemplary and not meant to be limiting, as alternative document types from the document types listed in operation 112 are possible. That is, other document types that may have structure information incorporated therein may be included in the list illustrated in operation 112. If it is determined that the document is one of the listed types of documents in operation 112, the method proceeds to operation 114 where the document is preprocessed. In the preprocessing stage, the algorithm scans through the document, identifies and extracts image and structure information inside the document. If the document is not one of the listed types of operation 112, the method terminates. Continuing with operation 114, upon completion of the preprocessing the method advances to decision operation 116 where it is determined if the document contains any images. For example, a Word document may have an image file contained therein.

Upon detection of the image file in operation 116 the method moves to operation 118 where the images are extracted from the document. The extracted images from operation 118 are delivered to optical structure recognition module 120 for processing. The optical structure recognition module 120 recognizes a chemical structure in vector graphics or raster graphics, and extracts text associated with the vector graphics or the raster graphics. The optical structure recognition module 120 then derives the compound structure information from the extracted text and the recognized chemical structure. The optical structure recognition algorithm is further described below with reference to FIG. 3. In addition, the document from operation 116 is processed by the name and metadata recognition module 126. Chemical names are extracted from the documents through module 128 and Collaboration and content management software system metadata information is extracted through module 130. If it is determined that the document does not contain any images in operation 116 then the method proceeds to decision operation 122 where it is determined if the document contains any MolString (molecular string) information. It should be appreciated that MolString information is a string representation of a structure that is readable by a drawing program, such as J draw, Symyx® draw, etc. If it is determined that MolString information is present in the document, the method moves to operation 124 where the structure information is retrieved and eventually stored in the relational database along with the document ID and document metadata. Module 126, which includes the chemical name extraction module 128 and Collaboration and content management system metadata information module 130 is essentially a text search module that searches for the chemical names, metadata properties, etc., in the document and in the metadata of the document. Metadata of the document may include user-applied tags or tags applied by a system.

Still referring to FIG. 1, the output of the optical structure recognition module 120 and the name and metadata recognition module 126 is processed in operation 132. The compound structure information, along with the metadata of the document from which the structure resides, is collected in operation 132. It should be appreciated that the compound structure information is a live structure, i.e., the compound structure information has more functionality than just an image file. For example, the compound structure information can be parsed out so that fragment-based searches or similarity searches can be performed. The compound structure information and the metadata collected in operation 132 are stored in a relational database in operation 134. It should be appreciated that the compound structure information may be represented as a MolString or other suitable format. In addition, the document ID, file name, file location and other associated metadata are stored in the relational database as illustrated in operation 134. In one embodiment, redundancy is reduced or eliminated prior to storing the compound structure information, the molecular string information, the compound structure information and the chemical name or names extracted from the document.

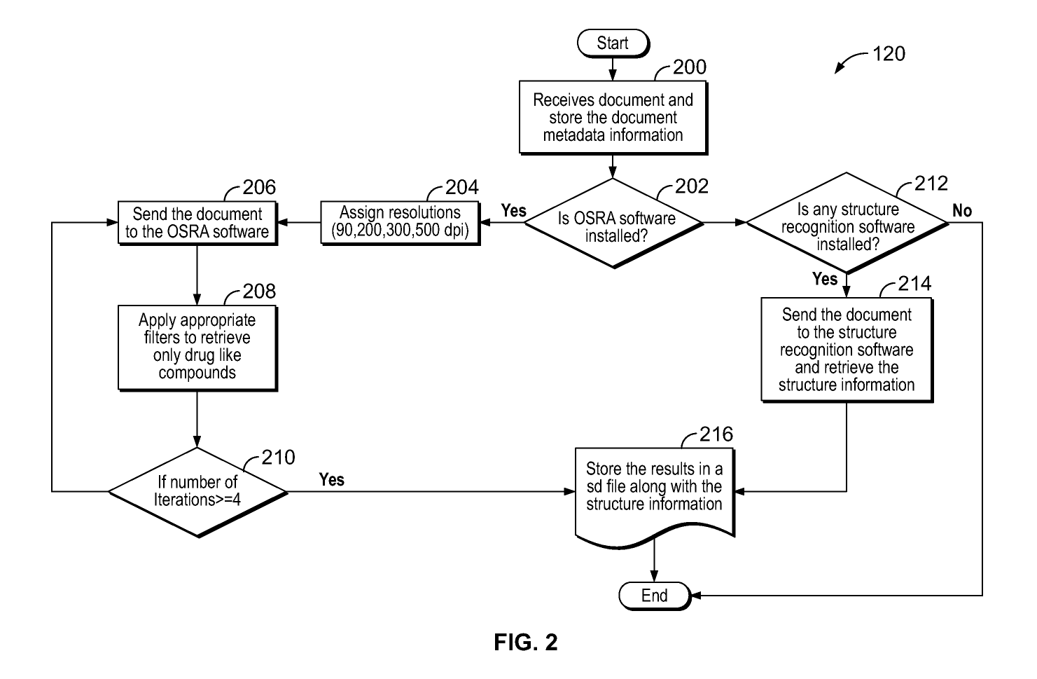

FIG. 2 is a flowchart diagram illustrating the method operations performed by the structure recognition module 120 of FIG. 1 in accordance with one embodiment. The method initiates with operation 200 where the document is received and the document metadata information is stored. The method advances to decision operation 202 where it is determined if the optical structure recognition algorithm (OSRA) is installed. If the optical structure recognition algorithm is installed on the computing device, the method advances to operation 204 where a resolution is assigned to the document data. The document is then sent or processed by the optical structure recognition algorithm at the assigned resolution in operation 206.

The optical structure recognition algorithm applies image recognition techniques to the document, in operation 206. The optical structure recognition algorithm can recognize a benzene ring and other chemical structures in an image. For example, a portable document format image may have text stored as content streams with position information, plus vector graphics for illustrations, designs, shapes or lines, or raster graphics for photographs or rasterized generated images. The optical structure recognition algorithm applies the position information of the text to associate text with lines in a drawing. When the algorithm recognizes a benzene ring or other chemical structure, the associated text and the structure are then extracted as compound structure information. Images in other formats are processed accordingly.

In operation 208, appropriate filters retrieve drug-like compounds, based upon organic drug discovery chemistry synthesis, research and development, and avoid the processing or storage of compounds that cannot be synthesized, or would likely lack predetermined characteristics, such as bioavailability or safety margins. It should be appreciated that the appropriate filters may include Lipinski's rule of 5, Molecular Weight, Number of Oxygen atoms, and similar filters, or other commercially available filters. The method then advances to decision operation 210 where it is determined if the number of iterations is greater than or equal to four. In one embodiment, the number of iterations to perform is empirically determined through benchmarking studies using publicly available datasets. The number of iterations to perform can be optimized based upon whether the optical structure recognition results have stabilized after a specified number of iterations or continue to improve with further iterations. Thus, the number of iterations is not limited to four and may be any whole number. If the number of iterations is not greater than or equal to four in this embodiment, the method repeats from operation 206 with a different resolution. In one embodiment each of the structures are stored in the database at the different dots per inch (dpi) resolutions and it is determined which resolution is optimum for processing. Upon the number of iterations being greater than four, the method proceeds to operation 216 where the results are stored in a structure data (sd) file, or other suitable chemical table file, along with the structure information. Returning to operation 202, if it is determined that the optical structural recognition algorithm is not available, the method advances to decision operation 212 where it is determined if any structure recognition software is installed on the computing device. Upon detection of suitable structure recognition software, the method advances to operation 214 where the document is processed by the recognition software in order to retrieve the structure information. The results of operation 214 are stored in a sd file, or other suitable chemical table file, along with the structure information as illustrated in operation 216. If it is determined that no structure recognition software is installed on the computing device in operation 212, the method terminates.

FIG. 3 is a flowchart diagram illustrating the method operations for extracting chemical names from a document in accordance with one embodiment. The method initiates with operation 300 where the document is received and the document metadata information is stored. In decision operation 302 it is determined if the document is configured for optical character recognition (OCR), i.e., the document has text that is susceptible to optical character recognition. If the document is configured for OCR, then the chemical names from the document are identified and extracted in operation 304. In operation 306, the generated chemical names are converted to a structure format, e.g., a MolString representation. In operation 308, filters are applied to store relevant compounds. As noted above with reference to FIG. 2, any commercially available filter may be utilized in order to avoid storage of compounds that cannot be synthesized. The results are then stored in a sd file along with the structure information as illustrated in operation 310. It should be appreciated that if the document is not configured for OCR in operation 302, then the method terminates.

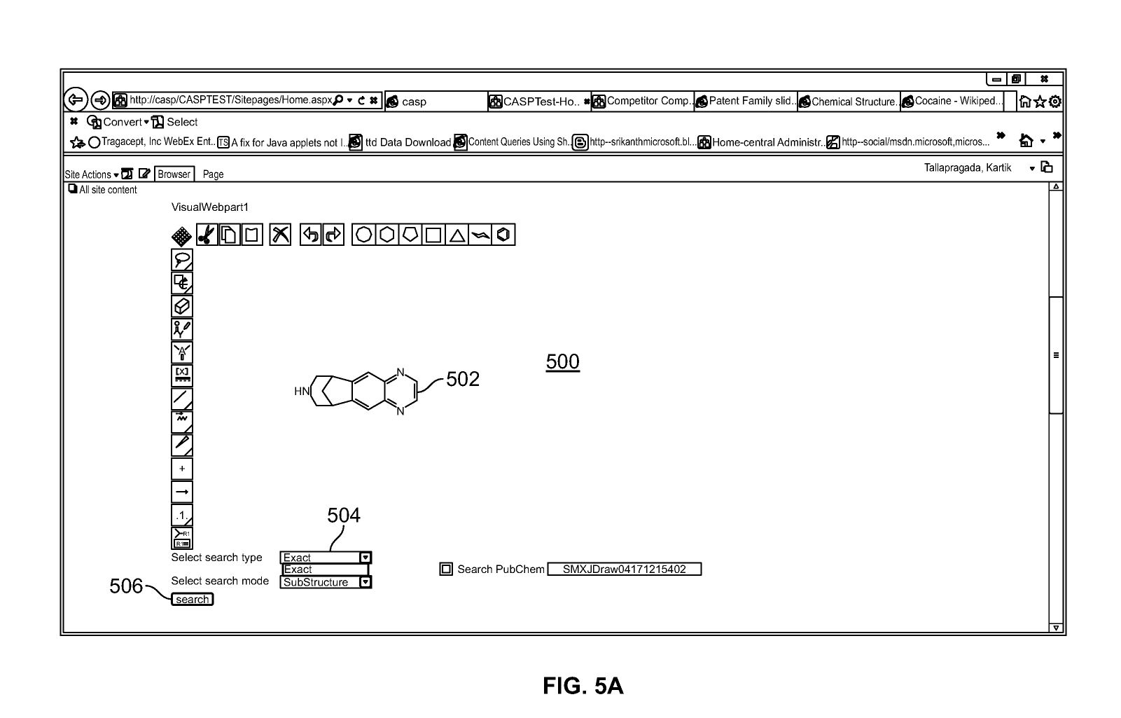

FIG. 4 is a flowchart diagram illustrating the method operations for obtaining metadata information in accordance with one embodiment. The method initiates with operation 400 where the document and associated tagged structure information is retrieved. In operation 402 the structure information document ID and any other metadata properties are stored in a relational database in one embodiment. It should be appreciated that metadata may include means of creation of the data, purpose of the data, time and date of creation, creator or author of the data, location on a computer network where the data were created, standards used, etc.

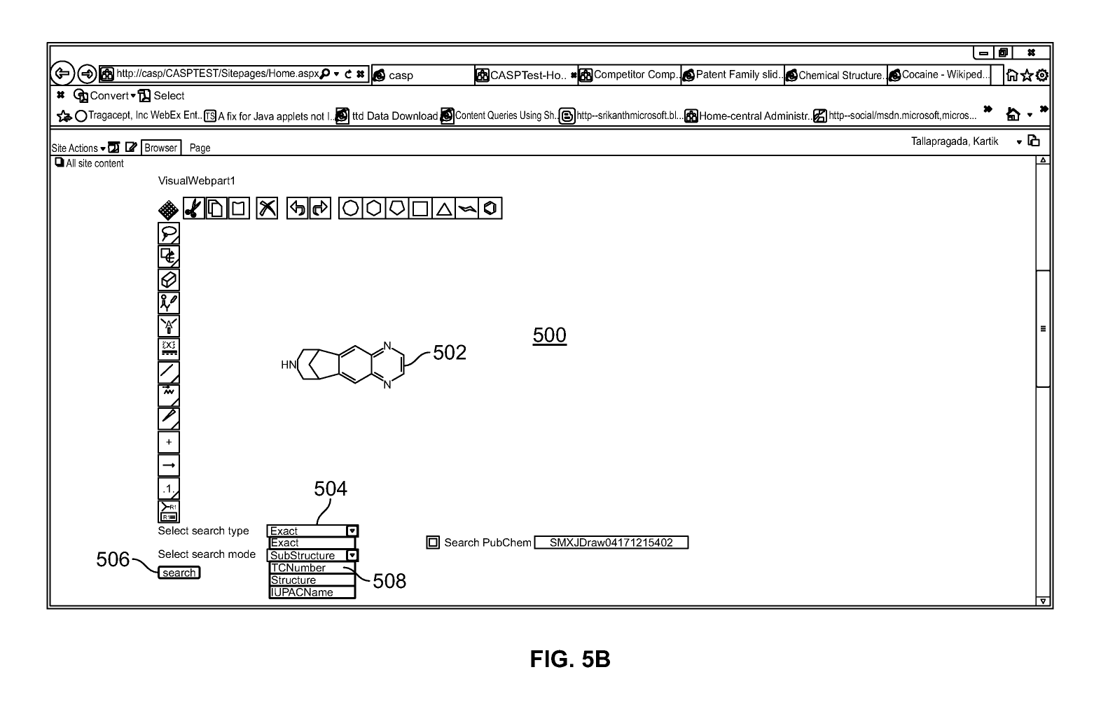

FIGS. 5A and 5B are simplified schematics illustrating graphical user interfaces where a user may initiate the enhanced search capability of the embodiments described herein. In FIG. 5A structure 502 is illustrated within GUI 500. It should be appreciated that GUI 500 may be integrated into a Collaboration and content management system application in accordance with one embodiment. In addition, GUI 500 may be any suitable drawing application. Drop-down menu 504 within the user interface enables the selection of a search type. In one embodiment the search type may be an exact match for the structure 502. In an alternative embodiment a fragment or substructure of structure 502 may be used for the search. In one embodiment, optical structure recognition is applied to the structure 502, in order to extract compound structure information. The extracted compound structure information is then applied in the search.

Button 506, when clicked on, triggers the search algorithm described above with reference to FIGS. 1 through 4. FIG. 5B illustrates drop-down menu 508 where a search mode is selected. As illustrated in drop-down menu 508, the search mode may be a structure search, an internal compound ID search, or an IUPAC (International Union of Pure and Applied Chemistry), or other naming convention, common, United States Adopted Names (USAN) or generic or brand name search. It should be appreciated that a structure search will trigger the enhanced features with improved accuracy where the search is performed utilizing each of modules 120, 128 and 130 of FIG. 1. An Internal Compound ID search and the IUPAC Name or other naming convention search trigger chemical name searches without the structure recognition search in one embodiment. The TC number listed in the dropdown as described in FIG. 5B is an internal compound ID. This feature converts the drawn structure to an internal compound ID and sends the compound ID to the search query.

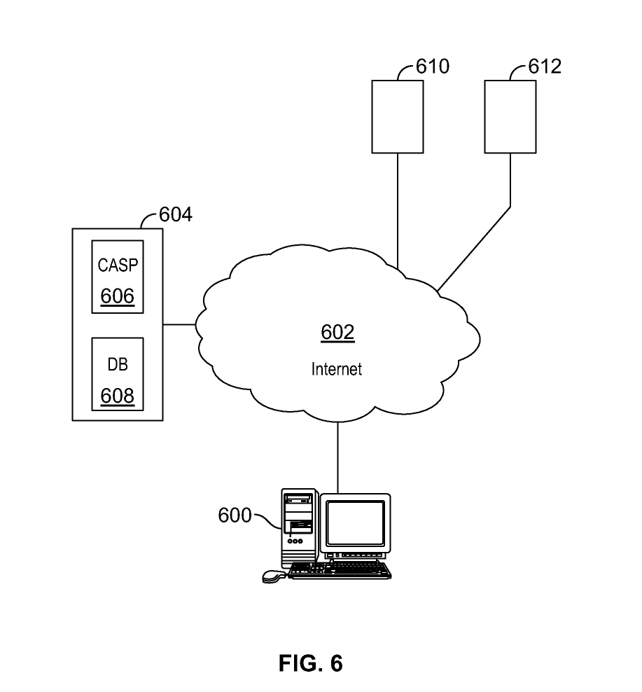

FIG. 6 is a simplified schematic diagram illustrating a computing system having the functionality described herein in accordance with one embodiment. Computing device 600 has access to Internet 602 and server 604. Server 604 includes the CHEMICALLY AWARE™ Collaboration and content management software system module 606. The server 604 includes a specially programmed processor. It should be appreciated that computing device 600 may be in communication with server 604 through an Intranet connection or some other secure connection. CHEMICALLY AWARE™ Collaboration and content management system module 606 may be a software module stored in memory and when executed through a processor performs the functionality described above with reference to FIGS. 1 through 5B. Relational database 608 is configured to store the data from the searches. It should be appreciated that relational database 608 may be an external database from server 604 in one embodiment. It should be further appreciated that the search algorithm may crawl Internet 602 and external databases 610 and 612 in order to locate pertinent documents for the associated searches. The data from these searches and the document information is eventually stored within relational database 608. External databases 610 and 612 may be any suitable chemical libraries, or other appropriate databases enabling access to documents having chemical structures. As noted above, the chemical structures may be represented as non-searchable image files or other types of searchable files. It should be appreciated that the information extracted from the documents and the information in a search request could include a drug name, a compound name, a trademarked drug name, a brand name, a generic drug name, a common drug name, a chemical name, a structural name, or a chemotype. Information retrieved from the relational database 608 is based upon matching the information to text information submitted in the search request or compound structure information extracted from a drawing submitted in the search request. The compound structure information could be extracted by applying the optical structure recognition module to the drawing.

In one embodiment, the computing system of FIG. 6 can handle documents of many types. Chemical names can be extracted from documents having a type of text format, i.e., documents there are at least partially text-based. Chemical names can be extracted from documents having text that is susceptible to optical character recognition. Compound structure information can be extracted from documents having an image, which may be raster-based or vector-based. Chemical names can be extracted from documents that have metadata, which may include tags. Molecular string information can be extracted from documents that have molecular string information. Documents with sections having differing formats have information extracted according to these formats. For example, a document that has an image-based portion and a text-based portion along with tags and molecular string information could have all of these subjected to extraction. The above-described extracted information is stored in the relational database 608 with links, pointers or other indicators of the relationships among the pieces of information. Location information of the document is stored in the relational database so that the original document can be retrieved. A search applied to the relational database then makes use of these relationships, so that a search under one chemical name can find documents with synonyms of that chemical name. In one embodiment, the search tool has a drawing tool with a search criteria feature. The search criteria feature allows selection of a filter, so that the user can select an exact matching, a substructure matching, or a similarity matching with respect to the drawn structure.

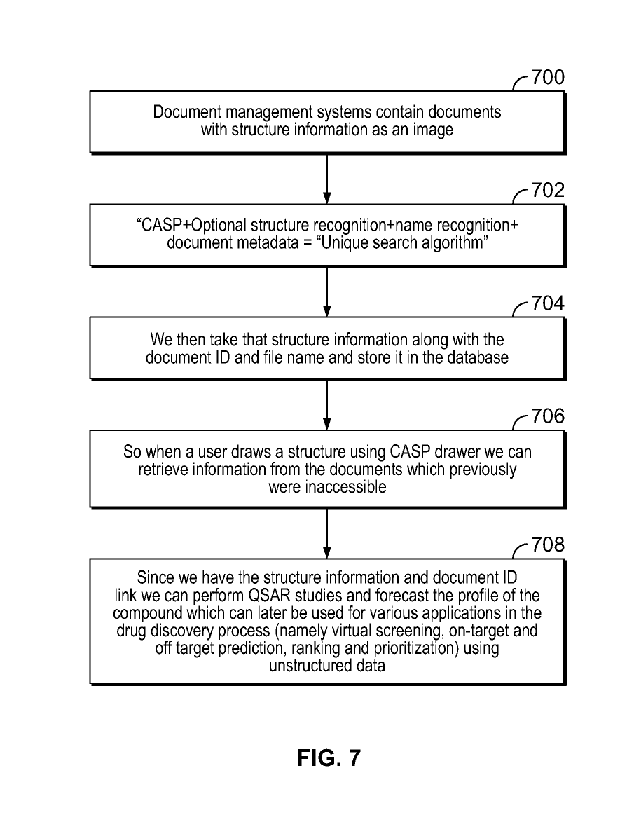

FIG. 7 is a flowchart diagram illustrating the high level method operations for the CHEMICALLY AWARE™ Collaboration and content management system functionality in accordance with one embodiment. The high level functionality illustrated in operations 700-708 enable a user to draw a structure using a drawing application as illustrated in FIGS. 5A and 5B in order to retrieve information from documents where the retrieved information was previously inaccessible. The embodiments build a relational database that enhances the drug discovery process. In operation 700 a document management system is provided that contains documents with structure information as an image. Thus, the structure image is non searchable image data for conventional tools. In operation 702, the chemically aware sharepoint (CASP) utilizes optical structure recognition, name recognition, and document metadata to search any documents. It should be appreciated that the functionality described with reference to FIG. 1 in operations 120, 128, and 130 may be executed here. In operation 704 the extracted data from operation 702 is stored in a database according to the document ID. In some embodiments a file name is stored along with the document ID. The database may be built and populated in an iterative process as mentioned above. Accordingly, when a user draws a structure as illustrated in FIGS. 5A and 5B, the information from previously searched documents organized in the database can be retrieved and presented to the user. In an extension of the embodiments, the retrieved data may be utilized to forecast the profile of compounds that may be later used in various applications in the drug discovery process as listed in operation 708.

The invention can also be embodied as computer readable code on a non-transient computer readable medium. The computer readable medium is any data storage device that can store data, which can thereafter be read by a computer system. The computer readable medium can also be distributed over a network-coupled computer system so that the computer readable code is stored and executed in a distributed fashion.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The embodiments can also be embodied as computer readable code on a computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Although the foregoing invention has been described in some detail for purposes of clarity of understanding, it will be apparent that certain changes and modifications can be practiced within the scope of the appended claims. The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of managing a database relating to chemical or molecular compounds, the method comprising:
extracting at least one first chemical name from the document in response to at least a portion of the document having a type of text format;
extracting compound structure information via optical structure recognition applied to the document in response to the document having at least one image;
extracting at least one second chemical name via optical character recognition applied to the document in response to the document having text that is susceptible to optical character recognition;
extracting at least one third chemical name from metadata of the document in response to the document having metadata;
extracting molecular string information from the document in response to the document having molecular string information; and
storing in a database, under an identifier associated with the document, the compound structure information, the at least one first chemical name, the at least one second chemical name, the at least one third chemical name, the molecular string information and the compound structure information.

2. The method of claim 1, further comprising:
storing in the database, under the identifier, a title of the document and location information of the document.

3. The method of claim 1, wherein the metadata includes at least one tag.

4. The method of claim 1, wherein the at least one first chemical name, the at least one second chemical name and the at least one third chemical name include at least one from a group consisting of: a drug name, a compound name, a trademarked drug name, a brand name, a generic drug name, a common drug name, a chemical name, a structural name, and a chemotype.

5. The method of claim 1, wherein the database is a relational database that indicates a relationship among the compound structure information, the at least one first chemical name, the at least one second chemical name, the at least one third chemical name, the molecular string information and the compound structure information.

6. The method of claim 1, further comprising:
eliminating redundancy in the at least one first chemical name, the at least one second chemical name, the at least one third chemical name, the molecular string information, and the compound structure information, as stored relating to the document.

7. The method of claim 1, further comprising:
searching in the database, in response to a search request that includes a structure illustrated within a graphical user interface.

8. A method of obtaining chemical or molecular compound information from a document, the method comprising:
applying optical structure recognition to a document;
extracting compound structure information from data obtained by applying the optical structure recognition;
applying a text search module to a main body of the document and metadata of the document;
extracting one or more chemical names from data obtained by applying the text search module to the main body and to the metadata; and
storing, in a database, an identifier, the compound structure information, and the one or more chemical names, wherein at least one method operation is executed through a processor.

9. The method of claim 8, wherein the document has a portable document format that includes text stored as a content stream with position information, and vector graphics or raster graphics.

10. The method of claim 8, further comprising:
applying to the compound structure information or to the one or more chemical names a filter that includes one from a set consisting of: Lipinski's rule of five, molecular weight, and number of oxygen atoms, wherein a decision of whether to store the compound structure information and the one or more chemical names is based upon a result from applying the filter.

11. The method of claim 8, wherein the optical structure recognition is applied to the document at more than one resolution value.

12. The method of claim 8, wherein the optical structure recognition is applied to the document iteratively.

13. The method of claim 8, further comprising:
accessing the database in response to a search that requests a match for a structure, a fragment or a substructure.

14. The method of claim 8, further comprising:
accessing the database in response to a search that requests a structure search or a search by name.

15. The method of claim 8, wherein each method operation is stored as program instructions on a computer-readable media.

16. A system for managing a database relating to chemical or molecular compounds, the system comprising:
a memory having a text search module and an optical structure recognition module stored therein;
a processor coupled to the memory and configured to execute instructions causing the processor to:
crawl through a plurality of documents;
extract one or more chemical names from a document of the plurality of documents via an application of the text search module to the document and via an application of the text search module to metadata of the document;
extract compound structure information from the document via an application of the optical structure recognition module to the document;
extract molecular string information from the document; and
store an identifier, location information of the document, the one or more chemical names, the compound structure information and the molecular string information.

17. The system of claim 16, further comprising:
a filter operable to determine if the compound structure information can be synthesized prior to storing the compound structure information, and wherein the identifier, location information of the document, the one or more chemical names, the compound structure information and the molecular string information are stored in a relational database.

18. The system of claim 16, further comprising the processor being configured to:
parse out the compound structure information so that fragment-based searches or similarity searches can be performed.

19. The system of claim 16, wherein the optical structure recognition module is configured to:
recognize a chemical structure in vector graphics or raster graphics;
extract text associated with the vector graphics or the raster graphics; and
derive the compound structure information from the extracted text and the recognized chemical structure.

20. The system of claim 16, wherein:
the search request includes a drawing of a molecular structure;
the processor is configured to extract further compound structure information from the drawing via an application of the optical structure recognition module to the drawing.
